(19) United States
(12) Patent Application Publication
(10) Pub. No.: US 2004/0226411 A1
(43) Pub. Date: Nov. 18, 2004

(54) Wrench structure having a driving mechanism

(76) Inventor: Chih-Ching Hsien, Taichung (TW)

Correspondence Address: Chih-Ching Hsien, 58, MA YUAN WEST ST., TAICHUNG, TW

(21) Appl. No.: 10/439,917

(22) Filed: May 15, 2003

(51) Int. Cl. B25B 17/00

(52) U.S. Cl. 81/57.13

(57) ABSTRACT

A wrench structure includes a wrench body, a rotation member, a driving mechanism, and a power supply device. Thus, the wrench structure can be both operated electrically and manually. In addition, the rotation member is wholly hidden in the drive head of the wrench body without detachment, thereby facilitating operation of the drive head of the wrench body. Further, the bevel gear of the driving rod and the bevel gear of the rotation member have a larger contact area, so that the wrench structure has a larger driving torsion.

### BACKGROUND OF THE INVENTION

1. Field of the Invention

The present invention relates to a wrench structure, and more particularly to a wrench structure having a driving mechanism that can be both operated electrically and manually.

2. Description of the Related Art

A conventional wrench can be used to operate and rotate a screw member, such as the bolt, nut or the like. However, the conventional wrench can only be operated manually, thereby consuming time of operation, and thereby wasting the user's manual work.

### SUMMARY OF THE INVENTION

The primary objective of the present invention is to provide a wrench structure that can be both operated electrically and manually.

Another objective of the present invention is to provide a wrench structure, wherein the rotation member is wholly hidden in the drive head of the wrench body without detachment, thereby facilitating operation of the drive head of the wrench body.

A further objective of the present invention is to provide a wrench structure, wherein the bevel gear of the driving rod and the bevel gear of the rotation member have a larger contact area, so that the wrench structure has a larger driving torsion.

A further objective of the present invention is to provide a wrench structure, wherein by provision of the bearing, the driving rod can be rotated in the handle of the wrench body smoothly and conveniently.

A further objective of the present invention is to provide a wrench structure, wherein the switch is mounted on the handle of the wrench body, thereby facilitating the user operating the switch to change operation direction of the wrench structure.

In accordance with the present invention, there is provided a wrench structure, comprising a wrench body, a rotation member, and a driving mechanism, wherein:

the wrench body has a first end formed with a drive head and a second end formed with a handle, the drive head of the wrench body is formed with a receiving chamber;

the rotation member is rotatably mounted on the drive head of the wrench body and includes a bevel gear rotatably mounted in the receiving chamber of the drive head of the wrench body;

the driving mechanism is mounted in the handle of the wrench body and includes a stator device, a driving rod, and a rotor device;

the stator device of the driving mechanism is secured in the handle of the wrench body;

the driving rod of the driving mechanism is rotatably mounted in the handle of the wrench body and has a first end provided with a bevel gear meshing with the bevel gear of the rotation member; and

the rotor device of the driving mechanism is rotatably mounted in the stator device and is secured on a second end of the driving rod for rotating the driving rod.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a wrench structure in accordance with the preferred embodiment of the present invention;

FIG. 2 is a perspective assembly view of the wrench structure in accordance with the preferred embodiment of the present invention;

FIG. 3 is a side plan cross-sectional view of the wrench structure as shown in FIG. 2;

FIG. 4 is a schematic operational view of the wrench structure as shown in FIG. 3 in use;

FIG. 5 is a schematic operational view of the wrench structure as shown in FIG. 3 in use;

FIG. 6 is a partially cut-away top plan cross-sectional assembly view of the wrench structure in accordance with another embodiment of the present invention; and

FIG. 7 is a side plan cross-sectional view of the wrench structure in accordance with another embodiment of the present invention.

### DETAILED DESCRIPTION OF THE INVENTION

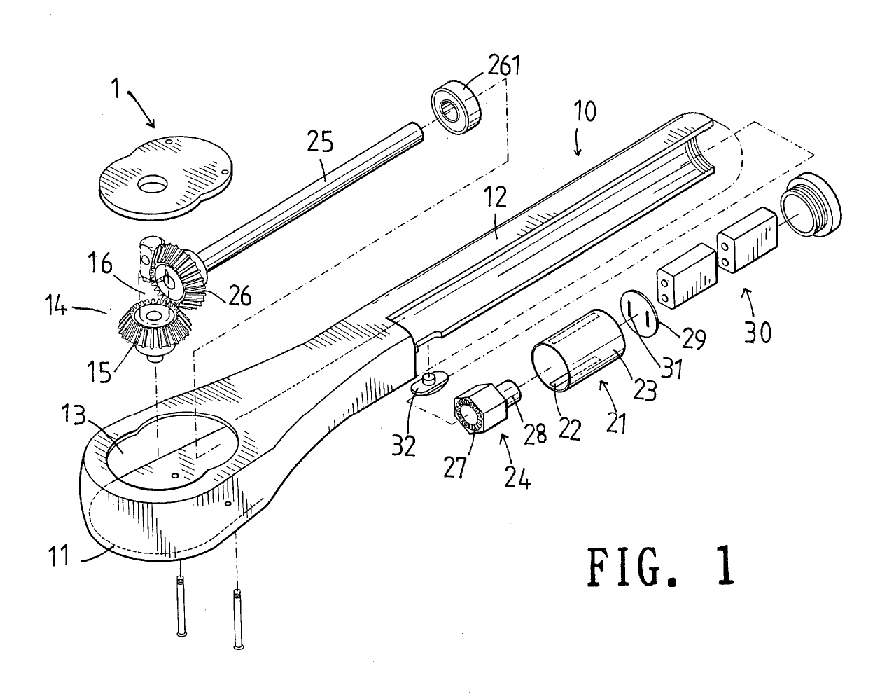

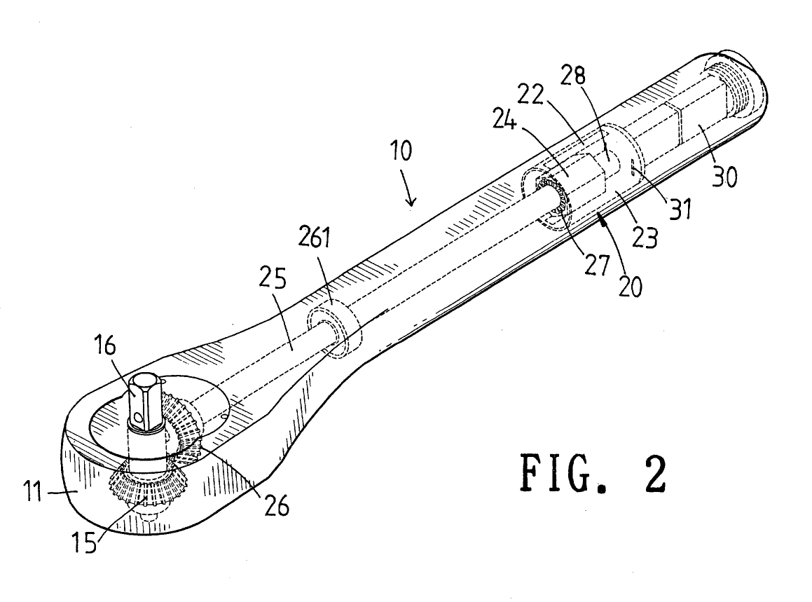

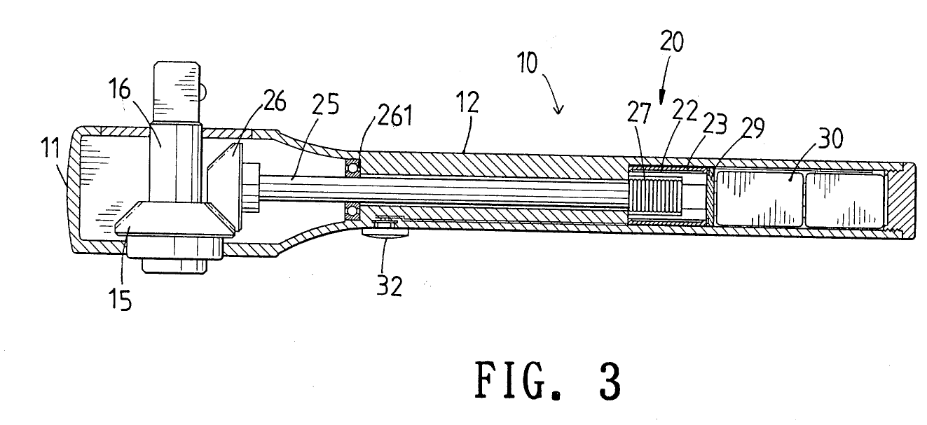

Referring to the drawings and initially to FIGS. 1-3, a wrench structure 1 in accordance with the preferred embodiment of the present invention comprises a wrench body 10, a rotation member 14, a driving mechanism 20, and a power supply device 30.

The wrench body 10 has a first end formed with a drive head 11 and a second end formed with a handle 12. The drive head 11 of the wrench body 10 is formed with a receiving chamber 13.

The rotation member 14 is rotatably mounted on the drive head 11 of the wrench body 10. The rotation member 14 includes a bevel gear 15 rotatably mounted in the receiving chamber 13 of the drive head 11 of the wrench body 10, and a protruding stud 16 having a first end secured on and rotated by the bevel gear 15 and a second end protruding outward from the receiving chamber 13 of the drive head 111 of the wrench body 10.

The driving mechanism 20 is mounted in the handle 12 of the wrench body 10. The driving mechanism 20 includes a stator device 21, a driving rod 25, a rotor device 24, and a conductive member 29.

The stator device 21 of the driving mechanism 20 includes a housing 23 secured in the handle 12 of the wrench body 10, and a permanent magnet 22 mounted in the housing 23.

The driving rod 25 of the driving mechanism 20 is rotatably mounted in the handle 12 of the wrench body 10 and has a first end provided with a bevel gear 26 meshing with the bevel gear 15 of the rotation member 14.

The driving mechanism 20 further includes a bearing 261 mounted in the handle 12 of the wrench body 10 and mounted on the driving rod 25, so that the driving rod 25 can be rotated in the handle 12 of the wrench body 10 smoothly and conveniently.

The rotor device 24 of the driving mechanism 20 is rotatably mounted in the housing 23 of the stator device 21 and is secured on a second end of the driving rod 25 for rotating the driving rod 25. The rotor device 24 of the driving mechanism 20 is provided with a coil 27 wound around the driving rod 25 and aligned with the permanent magnet 22 of the stator device 21. The rotor device 24 of the driving mechanism 20 has an end provided with a commutator 28.

The conductive member 29 of the driving mechanism 20 is mounted in the housing 23 and has a first side provided with an electric brush 31 rested on the commutator 28 of the rotor device 24.

The power supply device 30 is mounted in the handle 12 of the wrench body 10 and is rested on a second side of the conductive member 29. The wrench structure 1 further comprises a switch 32 mounted on the handle 12 of the wrench body 10 and connected to the power supply device 30 to control operation of the power supply device 30.

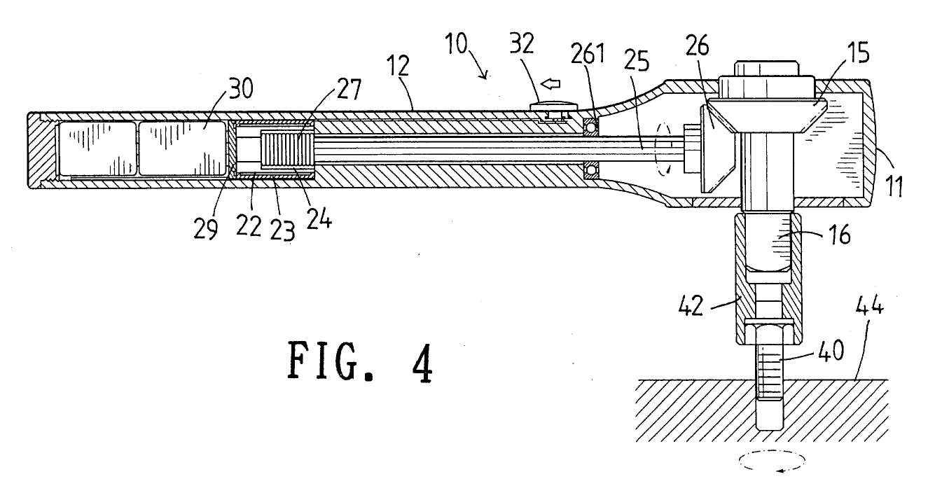

As shown in FIG. 4, the protruding stud 16 of the rotation member 14 is inserted into a socket 42 which is mounted on a screw member 40. Then, the switch 32 is pushed toward one side to turn on the power supply device 30 which supplies an electric current which flows through the electric brush 31 of the conductive member 29 and the commutator 28 of the rotor device 24 to conduct the coil 27 of the rotor device 24. After the coil 27 of the rotor device 24 is conducted and excited, the coil 27 of the rotor device 24 produces a magnetic field which produces a repulsion force relative to the permanent magnet 22 of the stator device 21 to drive and rotate the rotor device 24 to drive and rotate the driving rod 25 which rotates the bevel gear 26 which rotates the bevel gear 15 which rotates the protruding stud 16 which rotates the socket 42 which rotates the screw member 40, so as to screw the screw member 40 into an article 44.

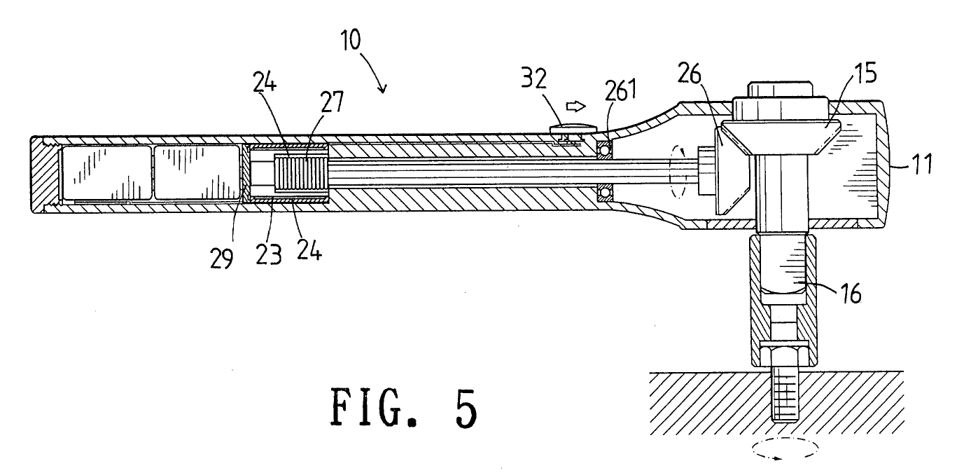

As shown in FIG. 5, the switch 32 is pushed toward the other side to control the commutator 28 of the rotor device 24 to change the direction of the electric current, so that the driving rod 25 can be rotated in the reverse direction to rotate the bevel gear 26 which rotates the bevel gear 15 which rotates the protruding stud 16 which rotates the socket 42 which rotates the screw member 40 in the reverse direction, so as to unscrew the screw member 40 from the article 44.

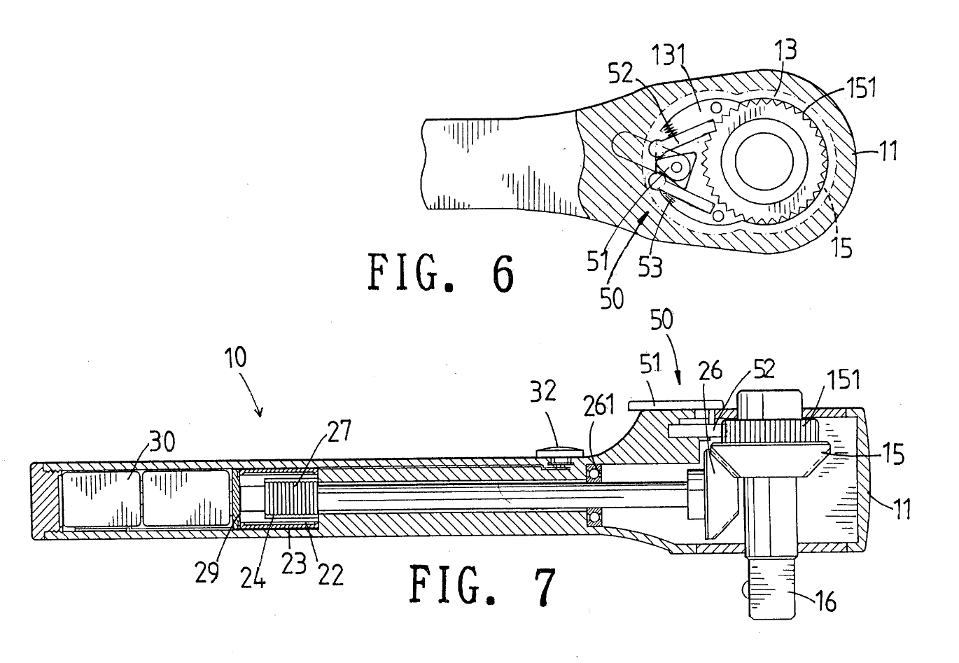

Referring to FIGS. 6 and 7, The wrench structure 1 further comprises a manual adjusting mechanism 50 mounted in a rear portion of the receiving chamber 13 of the drive head 11 of the wrench body 10. Preferably, the rear portion of the receiving chamber 13 of the drive head 111 of the wrench body 10 is formed with a receiving space 131 for receiving the manual adjusting mechanism 50. In addition, the bevel gear 15 of the rotation member 14 has a side provided with a toothed portion 151.

The manual adjusting mechanism 50 includes two pawl members 52 each pivotally mounted in the receiving space 131 of the drive head 111 of the wrench body 10 and each having a distal end meshing with the toothed portion 151 of the bevel gear 15 of the rotation member 14. The manual adjusting mechanism 50 further includes a control lever 51 pivotally mounted on the drive head 11 of the wrench body 10 and connected to each of the two pawl members 52 to control movement of each of the two pawl members 52. The manual adjusting mechanism 50 further includes two elastic members 53 each mounted between a wall of the receiving space 131 of the drive head 11 of the wrench body 10 and a respective one of the two pawl members 52.

In such a manner, when the power supply device 30 is inoperative, the control lever 51 can be pivoted to move one of the two pawl members 52 to lock the toothed portion 151 of the bevel gear 15 of the rotation member 14, so as to fix the rotation member 14 in the drive head 11 of the wrench body 10, so that the protruding stud 16 can be rotated by rotation of the drive head 111 of the wrench body 10 to rotate the socket 42 which rotates the screw member 40 so as to screw and unscrew the screw member 40 in a manual manner.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A wrench structure, comprising a wrench body, a rotation member, and a driving mechanism, wherein:
the wrench body has a first end formed with a drive head and a second end formed with a handle, the drive head of the wrench body is formed with a receiving chamber;
the rotation member is rotatably mounted on the drive head of the wrench body and includes a bevel gear rotatably mounted in the receiving chamber of the drive head of the wrench body;
the driving mechanism is mounted in the handle of the wrench body and includes a stator device, a driving rod, and a rotor device;
the stator device of the driving mechanism is secured in the handle of the wrench body;
the driving rod of the driving mechanism is rotatably mounted in the handle of the wrench body and has a first end provided with a bevel gear meshing with the bevel gear of the rotation member; and
the rotor device of the driving mechanism is rotatably mounted in the stator device and is secured on a second end of the driving rod for rotating the driving rod.

2. The wrench structure in accordance with claim 1, wherein the rotation member further includes a protruding stud having a first end secured on and rotated by the bevel gear and a second end protruding outward from the receiving chamber of the drive head of the wrench body.

3. The wrench structure in accordance with claim 1, wherein the stator device of the driving mechanism includes a housing secured in the handle of the wrench body, and a permanent magnet mounted in the housing.

4. The wrench structure in accordance with claim 3, wherein the rotor device of the driving mechanism is rotatably mounted in the housing of the stator device.

5. The wrench structure in accordance with claim 3, wherein the rotor device of the driving mechanism is provided with a coil wound around the driving rod and aligned with the permanent magnet of the stator device.

6. The wrench structure in accordance with claim 3, wherein the rotor device of the driving mechanism has an end provided with a commutator, and the driving mechanism further includes a conductive member mounted in the housing and having a first side provided with an electric brush rested on the commutator of the rotor device.

7. The wrench structure in accordance with claim 6, further comprising a power supply device mounted in the handle of the wrench body and rested on a second side of the conductive member.

8. The wrench structure in accordance with claim 7, further comprising a switch mounted on the handle of the wrench body and connected to the power supply device to control operation of the power supply device.

9. The wrench structure in accordance with claim 1, wherein the driving mechanism further includes a bearing mounted in the handle of the wrench body and mounted on the driving rod.

10. The wrench structure in accordance with claim 1, further comprising a manual adjusting mechanism mounted in a rear portion of the receiving chamber of the drive head of the wrench body.

11. The wrench structure in accordance with claim 10, wherein the rear portion of the receiving chamber of the drive head of the wrench body is formed with a receiving space for receiving the manual adjusting mechanism.

12. The wrench structure in accordance with claim 11, wherein the bevel gear of the rotation member has a side provided with a toothed portion, and the manual adjusting mechanism includes two pawl members each pivotally mounted in the receiving space of the drive head of the wrench body and each having a distal end meshing with the toothed portion of the bevel gear of the rotation member.

13. The wrench structure in accordance with claim 12, wherein the manual adjusting mechanism includes a control lever pivotally mounted on the drive head of the wrench body and connected to each of the two pawl members to control movement of each of the two pawl members.

14. The wrench structure in accordance with claim 12, wherein the manual adjusting mechanism includes two elastic members each mounted between a wall of the receiving space of the drive head of the wrench body and a respective one of the two pawl members.

15. The wrench structure in accordance with claim 12, wherein the control lever can be pivoted to move one of the two pawl members to lock the toothed portion of the bevel gear of the rotation member, so as to fix the rotation member in the drive head of the wrench body, so that the rotation member can be rotated by rotation of the drive head of the wrench body.
